(19) United States
(12) Patent Application Publication
(10) Pub. No.: US 2017/0032883 A1
(43) Pub. Date: Feb. 2, 2017

(54) COIL ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: Yong Min HONG, Suwon-si (KR); Moon Soo PARK, Suwon-si (KR); Jong Ho LEE, Suwon-si (KR); Min Hee KIM, Suwon-si, (KR)

(21) Appl. No.: 15/094,421

(22) Filed: Apr. 8, 2016

(30) Foreign Application Priority Data
Jul. 31, 2015 (KR) 10-2015-0108682

(51) Int. Cl. H01F 27/28; H01F 41/02; H01F 41/04; H01F 27/29; H01F 27/255

(52) U.S. Cl. CPC H01F 27/2804; H01F 27/2828; H01F 27/29; H01F 27/255; H01F 41/041; H01F 41/0233

(57) ABSTRACT

A coil electronic component includes a magnetic body in which first and second coil parts including coil pattern portions having a spiral shape and lead portions connected to end portions of the coil pattern portions are disposed. The lead portions are each exposed to a surface of the magnetic body, and the coil pattern portions are exposed to first and second side surfaces of the magnetic body in the width direction of the magnetic body, and margin parts are disposed to cover the coil pattern portions exposed to the first and second side surfaces of the magnetic body.

### CROSS-REFERENCE TO RELATED APPLICATION

This application claims the benefit priority to of Korean Patent Application No. 10-2015-0108682, filed on Jul. 31, 2015 with the Korean Intellectual Property Office, the entirety of which is incorporated herein by reference.

### TECHNICAL FIELD

The present disclosure relates to a coil electronic component and a method of manufacturing the same.

### BACKGROUND

An inductor, a coil electronic component, is a representative passive element configuring an electronic circuit, together with a resistor and a capacitor, to remove noise therefrom.

An inductor may be manufactured by forming coil parts in a magnetic body including a magnetic material and then forming external electrodes on an outer surface of the magnetic body.

### SUMMARY

An aspect of the present disclosure provides a coil component capable of alleviating exposure defects of coil parts and implementing high capacity, and a method of manufacturing the same.

According to an aspect of the present disclosure, a coil electronic component includes margin parts formed on first and second side surfaces of a magnetic body in a width direction of the magnetic body, and a method of manufacturing the same.

According to an aspect of the present disclosure, a coil electronic component comprises a magnetic body in which first and second coil parts including coil pattern portions having a spiral shape and lead portions connected to end portions of the coil pattern portions are disposed. The lead portions are each exposed to a surface of the magnetic body, and the coil pattern portions are exposed to first and second side surfaces of the magnetic body in the width direction of the magnetic body. Margin parts are disposed to cover the coil pattern portions exposed to the first and second side surfaces of the magnetic body.

According to another aspect of the present disclosure, a method of manufacturing a coil electronic component comprises steps of: forming a laminate by forming a plurality of first and second coil parts including coil pattern portions having a spiral shape and lead portions connected to end portions of the coil pattern portions, and laminating magnetic sheets on and below the first and second coil parts; and forming separate coils having the first and second coil parts embedded in a magnetic body by dicing the laminate. In the step of dicing the laminate, the coil pattern portions are diced to be exposed to first and second side surfaces of the magnetic body in a width direction of the magnetic body, and margin parts are formed to cover the coil pattern portions exposed to the first and second side surfaces of the magnetic body in the width direction of the magnetic body.

### BRIEF DESCRIPTION OF THE DRAWINGS

The above and other aspects, features, and other advantages of the present disclosure will be more clearly understood from the following detailed description taken in conjunction with the accompanying drawings.

FIG. 1 is a schematic perspective view illustrating a coil electronic component according to an exemplary embodiment so that a coil part of the coil electronic component is visible.

FIG. 2 is a cross-sectional view taken along line I-I′ of FIG. 1.

FIG. 3 is an exploded perspective view illustrating a magnetic body and margin parts of the coil electronic component according to an exemplary embodiment.

FIG. 4 is a cross-sectional view taken along line II-II′ of FIG. 1.

FIG. 5 is a plan view illustrating the magnetic body and the margin parts of the coil electronic component according to an exemplary embodiment.

FIGS. 6A, 6B, 7, and 8 are views schematically illustrating operations for manufacturing a coil electronic component according to an exemplary embodiment in the present disclosure.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship relative to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

Coil Electronic Component

Hereinafter, a coil electronic component manufactured according to an exemplary embodiment in the present disclosure, particularly, a thin film type inductor, will be described. However, the present disclosure is not limited thereto.

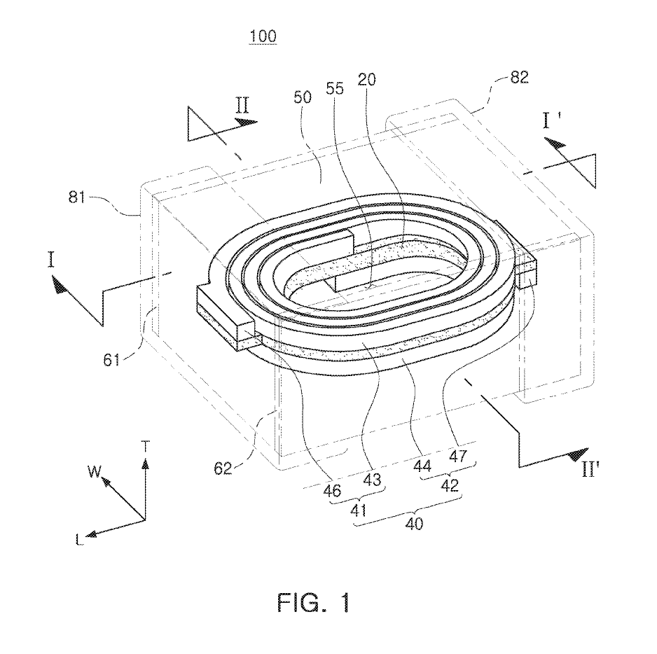

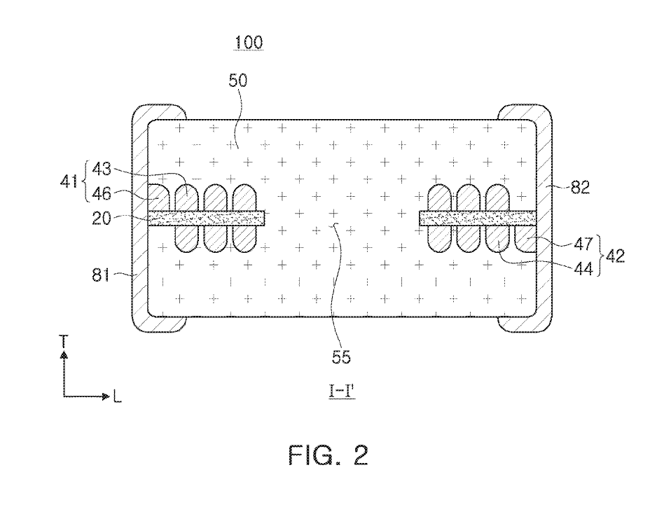

FIG. 1 is a schematic perspective view illustrating a coil electronic component according to an exemplary embodiment in the present disclosure so that a coil part of the coil electronic component is visible and FIG. 2 is a cross-sectional view taken along line I-I′ of FIG. 1.

Referring to FIG. 1, as an example of a coil electronic component, a thin film type inductor used in a power line of a power supply circuit is disclosed.

In a coil electronic component 100 according to an exemplary embodiment, a ‘length direction’ refers to an ‘L’ direction of FIG. 1, a ‘width direction’ refers to a ‘W’ direction of FIG. 1, and a ‘thickness direction’ refers to a ‘T’ direction of FIG. 1.

The coil electronic component 100 according to an exemplary embodiment may include a magnetic body 50, a coil part 40 embedded in the magnetic body 50, margin parts 61 and 62 disposed on first and second side surfaces of the magnetic body 50 in a width direction of the magnetic body 50, and first and second external electrodes 81 and 82 disposed on an outer surface of the magnetic body 50 and connected to the coil part 40.

The magnetic body 50 of the coil electronic component 100 according to an exemplary embodiment may include first and second coil parts 41 and 42.

The first coil part 41 having a plane coil shape may be formed on a first surface of a substrate 20 disposed in the magnetic body 50, and the second coil part 42 having the plane coil shape may be formed on a second surface of the substrate 20 opposing the first surface of the substrate 20.

The first and second coil parts 41 and 42 may be formed by performing electroplating on the substrate 20, but is not limited thereto.

The first and second coil parts 41 and 42 may be formed in a spiral shape, and the first and second coil parts 41 and 42 formed on the first and second surfaces of the substrate 20 may be electrically connected to each other through a via (not illustrated) formed to penetrate through the substrate 20.

The first and second coil parts 41 and 42 and the via may be formed of a metal having excellent electrical conductivity, such as silver (Ag), palladium (Pd), aluminum (Al), nickel (Ni), titanium (Ti), gold (Au), copper (Cu), platinum (Pt), alloys thereof, or the like.

The first and second coil parts 41 and 42 may be coated with an insulating layer (not illustrated) so as not to directly contact the magnetic material forming the magnetic body 50.

The substrate 20 may be formed of, for example, a polypropylene glycol (PPG) substrate, a ferrite substrate, a metal based soft magnetic substrate, or the like.

A central portion of the substrate 20 may be penetrated to form a through hole, and the through hole may be filled with the magnetic material to form a core part 55. As the core part 55 filled with the magnetic material is formed, inductance (L) may be improved.

However, the substrate 20 is not necessarily included, and the coil part may be formed of a metal wire without including the substrate 20.

The first and second coil parts 41 and 42 may respectively include coil pattern portions 43 and 44 having a spiral shape, and lead portions 46 and 47 connected to end portions of the coil pattern portions 43 and 44 and exposed to a surface of the magnetic body 50, respectively.

Referring to FIG. 2, the lead portions 46 and 47 may be formed by extending one end portion of each of the coil pattern portions 43 and 44, and may each be exposed to a surface of the magnetic body 50, respectively, to be connected to the first and second external electrodes 81 and 82 disposed on the outer surface of the magnetic body 50.

For example, as illustrated in FIG. 2, the lead portion 46 of the first coil part 41 may be exposed to one end surface of the magnetic body 50 in a length direction L of the magnetic body 50, and the lead portion 47 of the second coil part 42 may be exposed to the other end surface of the magnetic body 50 in the length L direction of the magnetic body 50.

However, the lead portions 46 and 47 are not limited thereto. For example, the respective lead portions 46 and 47 of the first and second coil parts 41 and 42 may be exposed to at least one surface of the magnetic body 50.

The magnetic body 50 of the coil electronic component 100 according to an exemplary embodiment disclosure may include a magnetic metal powder. However, the material forming the magnetic body 50 is not limited thereto, and the magnetic body may include any magnetic powder exhibiting magnetic properties.

The magnetic metal powder may be a crystalline or amorphous metal including any one or more selected from the group consisting of iron (Fe), silicon (Si), boron (B), chromium (Cr), aluminum (Al), copper (Cu), niobium (Nb), and nickel (Ni).

For example, the magnetic metal powder may be an Fe—Si—B—Cr based amorphous metal.

The magnetic metal powder may be included in a form in which it is dispersed in a thermosetting resin such as an epoxy resin, polyimide, or the like.

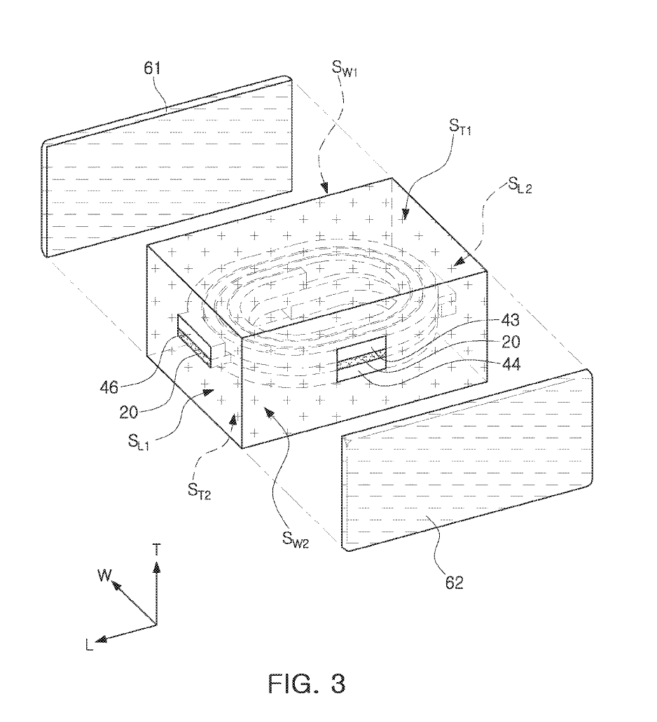

FIG. 3 is an exploded perspective view illustrating a magnetic body and margin parts of the coil electronic component according to an exemplary embodiment in the present disclosure.

Referring to FIG. 3, the magnetic body 50 of the coil electronic component 100 according to an exemplary embodiment may include first and second end surfaces S_{L1} and S_{L2} opposing each other in the length L direction of the magnetic body 50, first and second side surfaces S_{W1} and S_{W2} connecting the first and second end surfaces S_{L1} and S_{L2} and opposing each other in a width W direction of the magnetic body 50, and first and second main surfaces S_{T1} and S_{T2} opposing each other in a thickness T direction of the magnetic body 50.

The coil pattern portions 43 and 44 of the first and second coil parts 41 and 42 according to an exemplary embodiment may be exposed to the first and second side surfaces S_{W1} and S_{W2} of the magnetic body 50 in the width direction of the magnetic body 50.

Separate margin parts 61 and 62 may be disposed on the first and second side surfaces S_{W1} and S_{W2} to which the coil pattern portions 43 and 44 are exposed.

In the case of a conventional form of the coil electronic component in which the margin parts are not separately attached to the side surfaces of the magnetic body, in order to prevent the coil parts from being exposed to the side surfaces of the magnetic body, the magnetic body may be formed to have the margin parts spaced apart from each other by a predetermined interval at the side surfaces of the magnetic body.

However, an electrode exposure defect in which the margin parts are not properly formed by dicing bias during a process of dicing a laminate to form the magnetic body and the coil parts are exposed to the side surfaces of the magnetic body has occurred.

Further, due to an increase in an electrode step according to a large current of the coil electronic component, a delamination error rate has been increased.

In order to solve these problems, according to an exemplary embodiment, the separate margin parts 61 and 62 are disposed on the first and second side surfaces S_{W1} and S_{W2} of the magnetic body 50 in the width direction of the magnetic body 50. As a result, the electrode exposure defect may be prevented, and the delamination error rate may be reduced.

In addition, since the margin parts 61 and 62 are further attached to the first and second side surfaces S_{W1} and S_{W2} of the magnetic body 50, the margin parts are not required to be formed in the magnetic body 50. Thus, an area of the disposed coil part 40 may be significantly increased. As a result, high capacity may be implemented.

In addition, since the margin parts are not required to be formed in the magnetic body 50, the coil pattern portions 43 and 44 may be diced to be exposed to the first and second side surfaces S_{W1} and S_{W2} of the magnetic body 50 in the width direction of the magnetic body 50.

Thereby, cross sections of the exposed coil pattern portions 43 and 44 may have a straight line shape.

The margin parts 61 and 62 may be formed to be fixed to the first and second side surfaces S_{W1} and S_{W2} of the magnetic body 50 in the width direction of the magnetic body 50 to which the coil pattern portions 43 and 44 are exposed.

Boundaries between the magnetic body 50 and the margin parts 61 and 62 may be confirmed by using a scanning electron microscope (SEM), but the magnetic body 50 and the margin parts 61 and 62 are not necessarily classified by the boundaries observed by the SEM. For example, regions which are separately attached to the first and second side surfaces S_{W1} and S_{W2} of the magnetic body 50 may be classified as the margin parts 61 and 62.

The margin parts 61 and 62 may include a thermosetting resin.

For example, the margin parts 61 and 62 may include the thermosetting resin such as an epoxy resin, polyimide, or the like, but is not limited thereto. For example, as long as the resin has an insulating effect, any resin may be applied.

The margin parts 61 and 62 may be formed by coating the thermosetting resin on the first and second side surfaces S_{W1} and S_{W2} of the magnetic body 50 in the width direction of the magnetic body 50 to which the coil pattern portions 43 and 44 are exposed and then curing the coated thermosetting resin, but is not limited thereto.

The margin parts 61 and 62 may further include a magnetic metal powder. The margin parts 61 and 62 may further include the magnetic metal powder, whereby higher capacity may be implemented.

The margin parts 61 and 62 may include the magnetic metal powder of 3 to 70 wt %.

When the margin parts 61 and 62 include the magnetic metal powder at less than 3 wt %, an increase in the capacity may be inadequate. When the margin parts 61 and 62 include the magnetic metal powder at more than 70 wt %, however, a rate of increase in capacity may be small, and appearance defects may occur.

The margin parts 61 and 62 may be formed over the entirety of the first and second side surfaces S_{W1} and S_{W2} of the magnetic body 50 in the width direction of the magnetic body 50.

In order to effectively insulate the coil pattern portions 43 and 44 exposed to the first and second side surfaces S_{W1} and S_{W2}, the margin parts 61 and 62 may be formed over the entirety of the first and second side surfaces S_{W1} and S_{W2} of the magnetic body 50. However, the margin parts 61 and 62 are not limited to being formed over the entirety of the first and second side surfaces S_{W1} and S_{W2} of the magnetic body 50, and may also be formed on only a portion of the first and second side surfaces S_{W1} and S_{W2} of the magnetic body 50.

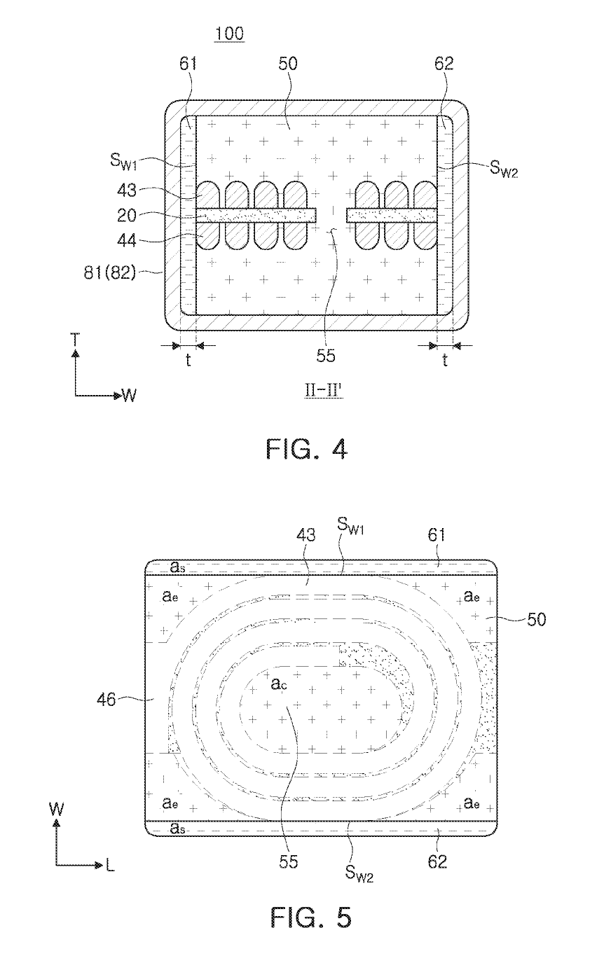

FIG. 4 is a cross-sectional view taken along line II-II′ of FIG. 1.

Referring to FIG. 4, the coil pattern portions 43 and 44 of the first and second coil parts 41 and 42 may be exposed to the first and second side surfaces S_{W1} and S_{W2} of the magnetic body 50, and the first and second margin parts 61 and 62 may be disposed on the first and second side surfaces of the magnetic body 50.

Since the coil part 40 is formed to have a maximum area so that the coil pattern portions 43 and 44 are exposed to the first and second side surfaces S_{W1} and S_{W2} of the magnetic body 50, high capacity may be implemented.

The margin parts 61 and 62 may have a width in the width direction of 10 μm to 40 μm.

When the width in the width direction of the margin parts 61 and 62 is less than 10 μm, the coil pattern portions 43 and 44 exposed to the first and second side surfaces S_{W1} and S_{W2} of the magnetic body 50 may not be insulated. When the width of the margin parts 61 and 62 exceeds 40 μm, however, a volume occupied by the margin parts 61 and 62 is increased too much, and thus it may be difficult to implement high capacity.

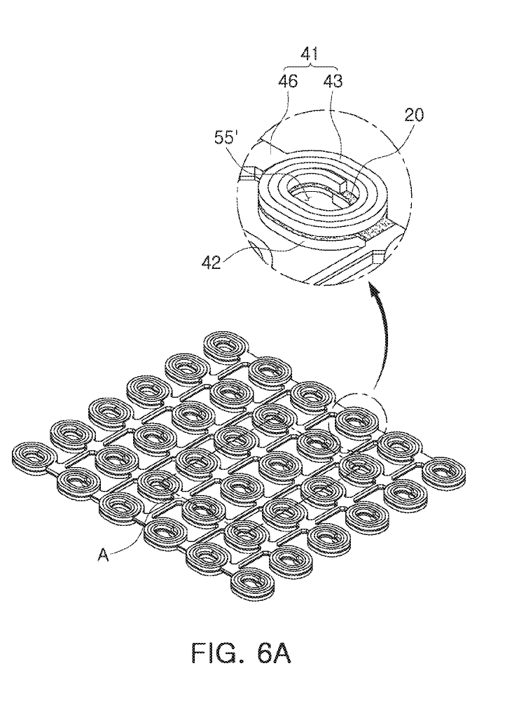

FIG. 5 is a plan view illustrating the magnetic body and the margin parts of the coil electronic component according to an exemplary embodiment in the present disclosure.

Referring to FIG. 5, according to an exemplary embodiment, when an area of a cross section of a core part 55 in a length-width L-W direction of the core part 55 formed in an inner portion of the first and second coil parts 41 and 42 is a_{c}, a summation of areas of cross sections of the magnetic body 50 in a length-width L-W direction of the magnetic body 50 outside the first and second coil parts 41 and 42 is aₑ, and a summation of areas of cross sections of the margin parts 61 and 62 in a length-width L-W direction of the margin parts 61 and 62 is aₛ, aₑ+aₛ≦a_{c} may be satisfied.

Since the margin parts 61 and 62 are further attached to the first and second side surfaces S_{W1} and S_{W2} of the magnetic body 50, the margin parts may not be required to be formed in the magnetic body 50. Thus, the first and second coil parts 41 and 42 may be formed to have the maximum area so that the coil pattern portions 43 and 44 are exposed to the first and second side surfaces S_{W1} and S_{W2} of the magnetic body 50.

As a result, the area a_{c} of the core part 55 formed in the inner portion of the first and second coil parts 41 and 42 may be increased, and aₑ+aₛ≦a_{c} may be satisfied.

According to an exemplary embodiment, as aₑ+aₛ≦a_{c} is satisfied, high capacity may be implemented.

Method of Manufacturing Coil Electronic Component

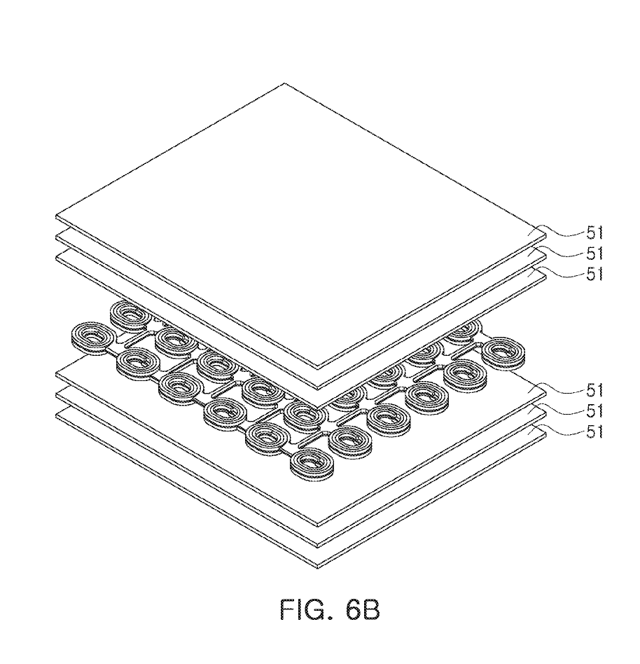

FIGS. 6A, 6B, 7, and 8 are views schematically illustrating processes for manufacturing a coil electronic component according to an exemplary embodiment in the present disclosure.

Referring to FIG. 6A, a plurality of coil parts 41 and 42 may be formed on first and second surfaces of a substrate 20.

The first and second coil parts 41 and 42, and a via (not illustrated) connecting the first and second coil parts 41 and 42 may be formed by forming a via hole (not illustrated) in the substrate 20, forming a plating resist having an open part on the substrate 20, and then filling the via hole and the open part with a conductive metal by plating.

The first and second coil parts 41 and 42, and the via may be formed of a conductive metal having excellent electrical conductivity, such as silver (Ag), palladium (Pd), aluminum (Al), nickel (Ni), titanium (Ti), gold (Au), copper (Cu), platinum (Pt), alloys thereof, or the like.

However, a method of forming the coil parts 41 and 42 is not limited to the above-mentioned plating process. For example, the coil parts may be formed of a metal wire.

The first and second coil parts 41 and 42 may include coil pattern portions 43 and 44 having a spiral shape, respectively, and lead portions 46 and 47 connecting end portions of the coil pattern portions 43 and 44, respectively.

An insulating layer (not illustrated) coating the first and second coil parts 41 and 42 may be formed on the first and second coil parts 41 and 42.

The insulating layer (not illustrated) may be formed by a method known in the art such as a screen printing method, an exposure and development process of a photoresist (PR), a spray applying method, or the like.

The substrate 20 may be formed of, for example, a polypropylene glycol (PPG) substrate, a ferrite substrate, a metal based soft magnetic substrate, or the like.

A central portion of a region of the substrate 20 on which the first and second coil parts 41 and 42 are not formed may be removed to form a core part hole 55′.

The removal of the substrate 20 may be performed by a mechanical drill method, a laser drill method, sand blasting, a punching method, or the like.

Referring to FIG. 6B, a laminate may be formed by stacking magnetic sheets 51 on and below the first and second coil parts 41 and 42.

The magnetic sheets 51 may be manufactured in a sheet by manufacturing a slurry by mixing a magnetic metal powder with an organic material such as a thermosetting resin, a binder, a solvent, or the like, applying the slurry on a carrier film at a thickness of several tens of μm by a doctor blade method, and then drying the applied slurry.

The magnetic sheet 51 may be manufactured in a form in which the magnetic metal powder is dispersed in a thermosetting resin such as an epoxy resin, polyimide, or the like.

The laminate in which the coil parts 41 and 42 are embedded may be formed by laminating, compressing, and curing the magnetic sheets 51.

In this case, the core part hole 55′ may be filled with a magnetic material to form the core part 55.

However, although FIG. 6B illustrates a process of forming the laminate 50 in which the coil parts 41 and 42 are embedded by stacking the magnetic sheets 51, a method of forming the laminate 50 is not limited thereto, and as long as a method may form a magnetic metal powder-resin composite in which the coil parts are embedded, any method may be used.

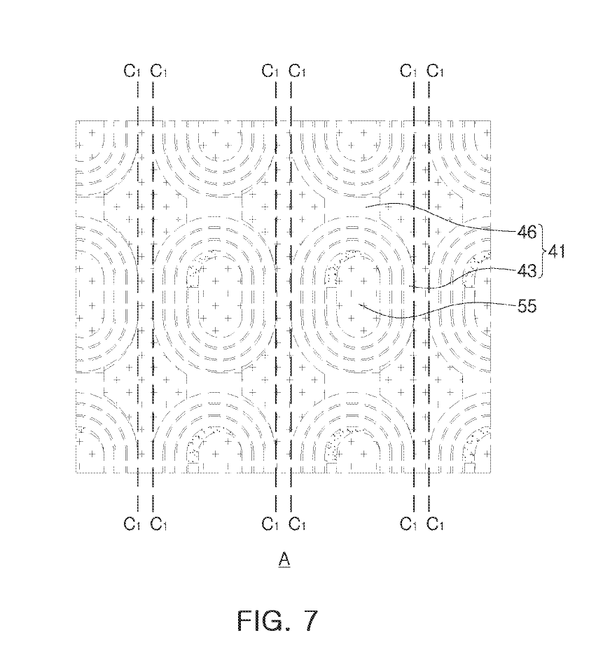

Referring to FIG. 7, the laminate may be diced along a dicing line C₁-C₁ so that the coil pattern portions 43 and 44 are exposed.

In the operation of dicing the laminate, the coil pattern portions may be diced to be exposed to first and second side surfaces of the magnetic body in a width direction of the magnetic body.

Thereby, cross sections of the exposed coil pattern portions 43 and 44 may have a straight line shape.

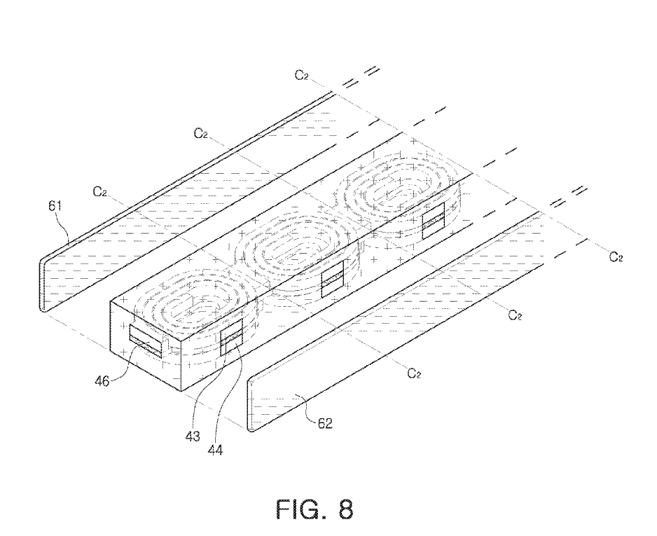

Referring to FIG. 8, margin parts 61 and 62 may be formed on the side surface of the magnetic body to which the coil pattern portions 43 and 44 are exposed, and the laminate may be diced along a dicing line C₂-C₂ to form separate coils having the first and second coil parts 41 and 42 embedded in the magnetic body 50.

An order of the operation of forming the margin parts 61 and 62 and the operation of dicing the laminate to form the separate coils is not limited thereto.

As illustrated in FIG. 8, after the margin parts 61 and 62 are formed, the laminate may be diced into the separate coils, and after the laminate is diced into the separate coils, the respective margin parts 61 and 62 may be formed.

By the operation of dicing the laminate, the lead portions 46 and 47 may be exposed to the first and second end surfaces S_{L1} and S_{L2} of the magnetic body 50 in the length direction of the magnetic body 50, and the coil pattern portions 43 and 44 may be exposed to the first and second side surfaces S_{W1} and S_{W2} of the magnetic body 50 in the width direction of the magnetic body 50.

In the method of manufacturing a coil electronic component according to an exemplary embodiment, since the margin parts 61 and 62 are formed on the first and second side surfaces S_{W1} and S_{W2} of the magnetic body 50, the margin parts may not be required to be formed in the magnetic body 50. Thus, the first and second coil parts 41 and 42 may be formed to have the maximum area. As a result, high capacity may be implemented.

The margin parts 61 and 62 may be formed by applying the thermosetting resin such as an epoxy resin, polyimide, or the like onto the side surfaces of the magnetic body 50 to which the coil pattern portions 43 and 44 are exposed and then curing the applied thermosetting resin, but are not limited thereto.

The margin parts 61 and 62 may further include a magnetic metal powder. The margin parts 61 and 62 may further include the magnetic metal powder, whereby higher capacity may be implemented.

The margin parts 61 and 62 may include the magnetic metal powder at between 3 and 70 wt %, based on a total weight of the margin parts.

When the margin parts 61 and 62 include the magnetic metal powder at less than 3 wt %, an increase in capacity may be inadequate. When the margin parts 61 and 62 include the magnetic metal powder at more than 70 wt %, however, a rate of capacity increase may be small, and appearance defects may occur.

The margin parts 61 and 62 may be formed to have a width of 10 μm to 40 μm.

When the width of the margin parts 61 and 62 is less than 10 μm, the coil pattern portions 43 and 44 exposed to the first and second side surfaces S_{W1} and S_{W2} of the magnetic body 50 may not be adequately insulated. When the width of the margin parts 61 and 62 exceeds 40 μm, however, it may be difficult to implement high capacity because the volume occupied by the margin parts 61 and 62 is increased too much.

Except for the above-mentioned description, a description of characteristics overlapping those of the coil electronic component according to an exemplary embodiment described above will be omitted.

As set forth above, according to the exemplary embodiments, exposure of the coil parts is prevented, whereby a dicing defect of the coil parts may be alleviated and high capacity may be implemented.

While exemplary embodiments have been shown and described above, it will be apparent to those skilled in the art that modifications and variations could be made without departing from the scope of the present invention as defined by the appended claims.

What is claimed is:

1. A coil electronic component comprising:
a magnetic body in which first and second coil parts including coil pattern portions having a spiral shape and lead portions connected to end portions of the coil pattern portions are disposed,
wherein the lead portions are each exposed to a surface of the magnetic body, and
the coil pattern portions are exposed to first and second side surfaces of the magnetic body in a width direction of the magnetic body, and margin parts are disposed to cover the coil pattern portions exposed to the first and second side surfaces of the magnetic body.

2. The coil electronic component of claim 1, wherein the margin parts include a thermosetting resin.

3. The coil electronic component of claim 2, wherein the margin parts further include a magnetic metal powder.

4. The coil electronic component of claim 3, wherein the margin parts include the magnetic metal powder at 3 to 70 wt %, based on a total weight of the margin parts.

5. The coil electronic component of claim 1, wherein the margin parts have a width in the width direction of the magnetic body between 10 μm and 40 μm.

6. The coil electronic component of claim 1, wherein the margin parts cover the entirety of the first and second side surfaces of the magnetic body in the width direction of the magnetic body.

7. The coil electronic component of claim 1, wherein the exposed coil pattern portions have a cross section of a straight line shape.

8. The coil electronic component of claim 1, wherein aₑ+aₛ≦a_{c}, where a_{c} is an area of a cross section in a length-width L-W direction of a core part formed in an inner portion of the first and second coil parts, aₑ is a summation of areas of cross sections in the length-width L-W direction of the magnetic body outside the first and second coil parts, and aₛ is a summation of areas of cross sections in the length-width L-W direction of the margin parts.

9. A method of manufacturing a coil electronic component, the method comprising steps of:
forming a laminate by forming a plurality of first and second coil parts including coil pattern portions having a spiral shape and lead portions connected to end portions of the coil pattern portions, and laminating magnetic sheets on and below the first and second coil parts; and
forming separate coils having the first and second coil parts embedded in a magnetic body by dicing the laminate,
wherein in the step of dicing the laminate, the coil pattern portions are diced to be exposed to first and second side surfaces of the magnetic body in a width direction of the magnetic body, and
margin parts are formed to cover the coil pattern portions exposed to the first and second side surfaces of the magnetic body in the width direction of the magnetic body.

10. The method of claim 9, wherein the margin parts include a thermosetting resin.

11. The method of claim 10, wherein the margin parts further include a magnetic metal powder.

12. The method of claim 11, wherein the margin parts include the magnetic metal powder at 3 to 70 wt %, based on a total weight of the margin parts.

13. The method of claim 9, wherein the margin parts have a width in the width direction of the magnetic body between 10 μm and 40 μm.

14. The method of claim 9, wherein the margin parts cover the entirety of the first and second side surfaces of the magnetic body in the width direction of the magnetic body.

15. The method of claim 9, wherein aₑ+aₛ≦a_{c}, where a_{c} is an area of a cross section in a length-width L-W direction of a core part formed in an inner portion of the first and second coil parts, aₑ is a summation of areas of cross sections in the length-width L-W direction of the magnetic body outside the first and second coil parts, and aₛ is a summation of areas of cross sections in the length-width L-W direction of the margin parts.
